(19) United States
(12) Patent Application Publication
(10) Pub. No.: US 2026/0152954 A1
(43) Pub. Date: Jun. 4, 2026

(54) Wall-Top Construction Creeper

(71) Applicant: Brett Reeder, Gilbert, SC (US)

(72) Inventor: Brett Reeder, Gilbert, SC (US)

(21) Appl. No.: 18/966,798

(22) Filed: Dec. 3, 2024

(51) Int. Cl. E04G 3/28

(52) U.S. Cl. CPC E04G 3/28; E04G 2003/283

(57) ABSTRACT

A wall-top mechanical creeper is designed to be used on top of framed walls during construction, and preferably includes a generally horizontal platform having a series of rotatable rollers disposed on an underside thereof. The horizontal platform includes a front transverse side, a rear transverse side and two longitudinal sides. Each longitudinal side of the platform is attached to a skid plate that is preferably attached thereto via hinge or other mechanism that allows the skid plates to pivot with respect to the platform. Each skid plate preferably includes a pivoting stirrup, wherein each stirrup includes a generally horizontal step member. In a preferred embodiment, a cushion is affixed to the upper surface of the platform. The mechanical creeper may be used on top of walls and wall frames during construction, allowing a worker to sit or lie on the platform and roll along the top of the wall.

### BACKGROUND OF THE INVENTION

Mechanical creepers have been developed over the years to assist workers of various professions with daily tasks that require the worker to move about in a confined area. For example, mechanics, plumbers, electricians and the like have used creepers to assist in moving around underneath automobiles, cabinets, and other confined spaces. Generally, creepers are simply mobile platforms that have wheels attached thereto, so that a worker may sit or lay down on the creeper, thus allowing a worker to easily move about on the wheeled platform while in a horizontal or sitting position. Some of the mechanical creepers that have been developed heretofore include additional features, such as pivoting backrests that may be positioned either in a flat, horizontal position, or may be raised up to a desired angle for worker back support while in a seated our lounging type of position.

One area where mechanical creepers have not yet been developed to any significant degree, if at all, is in construction, particularly with respect to framing. When construction workers are framing a building, they oftentimes must climb on top of a framed wall, in order to attach ceiling joists, beams, and other structural components that are attached to the upper edge of a framed wall. The worker who is performing this kind of construction must sit on top of the wall, or on a ladder, and either slide himself or herself across the top of the wall, or must come down from the ladder and reposition the ladder in order to accomplish the task at hand. It would be desirable, therefore, to develop a mechanical creeper assembly that could be placed on the top edge of a framed wall, so that the creeper could easily be moved along the top of the wall while the construction worker is performing his tasks.

Various types of mechanical creepers have been designed for different purposes, and the following documents illustrate some examples of mechanical creepers that are in existence today. The documents cited herein are hereby incorporated herein by reference, in their entireties:

U.S. Pat. No. 4,957,302 Worker Support Apparatus

A support apparatus for selectively supporting a human being in one of a plurality of positions includes a support structure and a seat assembly having a frame and a seat mounted on the frame for movement therewith. The seat assembly is positionable relative to support structure along an arcuate path defined by an arcuate guide track provided on one of the frame and support structure. A plurality of rollers are rotatably supported on the other of the frame and support structure, the rollers engaging the guide track to support the seat assembly on the support structure and being movable relative to the guide track to permit movement of the seat assembly relative to the support structure. A back support member may be pivotally mounted on the frame to permit selective positioning of the back support member in one of a plurality of positions relative to the seat while moving with the seat during movement of the seat assembly relative to the support structure.

U.S. Pat. No. 5,108,118 Mechanic's Creeper

A mechanic's creeper having improved strength and increased mobility without sacrifice in work height, for use on a work surface is disclosed. The improved creeper comprises a triangular array of three straight castors, an integral frame suspended from the castors. The frame comprises a plurality of structural members and a plurality of weight bearing cross-bracing members engaging the castors, thereby transferring the weight of the structural members and any load placed thereupon to the castors.

U.S. Pat. No. 5,261,725 Low-profile Positioning Apparatus

A support apparatus for supporting a user in a plurality of working positions includes a seat supported on a frame and a seat back connected to the frame for movement between a plurality of angular positions ranging between a horizontal position and an upright position. The seat back is positioned in any of the angular positions by a carriage which supports the seat back for pivotal movement about a horizontal axis and by a shifting structure which carries out translational movement of the seat back relative to the pivot axis during pivoting movement of the seat back. The shifting structure shifts the seat back toward the seat during pivotal movement toward the horizontal position and away from the seat during pivotal movement toward the upright position so that the positional relationship between the seat back and the back of a user is preserved.

U.S. Pat. No. 7,114,742 Creeper Apparatus for use on Rough Uneven Train

A creeper apparatus for use on rough uneven terrain includes body means having an anterior portion and a posterior portion, wherein the anterior portion and the posterior portion are spaced in an angular relationship at a juncture between the anterior and posterior portions; axle means fixedly connected to the body means in close proximity to the juncture between the anterior and posterior portions, the axle means having a first end and a second end extending transversely outwardly from the body means; wheel means including a pair of opposing wide tread resilient wheels, one rotatable mounted on each of the first and second ends of the axle means; and stabilizing means connected to the posterior portion of the body means.

U.S. Pat. No. 7,363,864 Mechanic's Track Creeper

A mechanic's track creeper is described, which includes a body, and a rail interface coupled to the body, wherein the rail interface of the creeper is operatively engageable with a rail having a translational axis, wherein the rail interface of the creeper comprises a means for ensuring proper alignment of the rail interface relative to the rail, and wherein the creeper is enabled to translate from a first position to a second position along the translational axis of the rail. A track including such a rail is also described, with an elongated dimension defining a translational axis, wherein the rail interface of the creeper is operatively engageable with the rail, and wherein the creeper is enabled to translate from a first position to a second position along the translational axis of the track.

U.S. Pat. No. 9,126,325 Railcare Maintenance Creeper

A creeper is provided wherein the creeper has a main frame comprising a front and a rear; wheels attached to the main frame; a handle attached to the mainframe rearward of said wheels; a platform slidably attached to the main frame and rail engagement brackets attached to the mainframe forward of the wheels. Pressure is applied to the handle thereby lifting the front of the main frame thereby supporting the creeper on the wheels. The creeper is moved to a position under the railcar. Pressure is removed from the handle thereby allowing the front of the creeper to lower wherein the rail engagement brackets engage with rails of a track. The personnel lays on the platform and slides the platform under the railcar.

U.S. Pat. No. 9,379,528 Cable Tray Service Trolley

A cable tray trolley having a cushioned body configured to support a human, a frame configured to support the body and wheels that roll atop the rails of a cable tray to enable the trolley to travel along the length of the cable tray, the cable tray supporting the trolley. The trolley has adjustable torso and pelvic cushions and an adjustable leg support. The trolley also comprises a brake mechanism to slow or stop the travel of the trolley along the length of the cable tray. The trolley wheels are attached to the frame with adjustable shafts to enable the trolley to fit cable trays of varying widths

U.S. Pat. No. 10,266,197 Ridable Kart

A ridable kart can have a body that supports a front wheel and movable rear wheels. The kart can include a motor that supports and drives the rear wheels. The motor and rear wheels are configured to tilt and rotate relative to the body of the kart. The body of the kart includes a concave space in which the front and rear wheels are positioned so that they are at least partially concealed by the body when viewed from the side of the kart.

U.S. Pat. No. 10,843,329 All Terrain Creeper

A creeper includes a frame having opposed side rails with first and second ends. A first wheel is carried by and extends above each side rail and is spaced a first distance from the first end of the side rails. A second wheel is carried by and extends above each side rail and is spaced a second distance from the second end of the side rails. The first distance is less than the second distance, and the wheels are spaced from each other a third distance which is less than the first and second distances. A fender is carried by each side rail and each fender covers a pair of the first and second wheels.

U.S. Pat. No. 11,097,412 Mechanic's Creeper Assembly

A mechanic's creeper assembly includes a panel that can be worn on a user's back. A first belt is slidably coupled to the panel and the first belt can be wrapped around the user to retain the panel on the user's back. A second belt is slidably coupled to the panel and the second belt can be wrapped around the user to retain the panel on the user's back. A pair of wheel mounts is each of the wheel mounts is coupled to opposite sides of the panel and each of the wheel mounts has a plurality of engagement points thereon. A pair of wheel units is provided and each of the wheel units is removably coupled to a respective one of the wheel mounts for rolling along the ground. Each of the wheel units engages a selected one of the engagement points in the respective wheel mount thereby spacing each of wheel units a selectable distance below the panel.

### U.S Patent Application No. 2009/0102147 Small Space Rough Terrain Mobility Transport

A small space rough terrain mobility transport for assisting a person in moving through a small low clearance space with rough terrain such as the crawl space beneath a building. The inventive device includes a deck assembly 10, a plurality of axle studs 40, a plurality of wheel assemblies 20 and padding 30. The deck assembly 10 includes turned up edges at each side to create a wheel guard 12 that protects the operator from contact with the wheels 20 and provides the means to control the direction of travel. The wheels 20 are of a size to fit into a low clearance area while maintaining low resistance while rolling across rough and soft surfaces such as soils. The wheel tread 24 are conducive for providing traction across rough terrain and soft soils. The wheel construction is sufficiently flexible to provide shock absorption. A material that is placed on top of the deck surface 11 and is water and tear resistant while being sufficiently soft to provide shock absorbing characteristics while shaped in a profile for the comfort of the operator. The axle stud 40 has an attachment end 42 and an axle end 41. The shape of the axle stud 40 is cylindrical and is preferably larger in diameter at the attachment end 42 than the axle end 41 and creates a shoulder 43 to support one of the two sides of the wheel assembly 20. Further the length of the widened attachment end 42 is a length sufficient to provide adequate clearance between the wheel assembly 20 and the wheel guard 12 that it is attached to. The axle stud 40 is smaller in diameter at the axle end 41 and is continuously straight for a length to be equal to the width of the wheel assembly hub 23 plus the thickness of the attachment washers 21 and threaded nut 22 necessary to secure the wheel assembly 20 to the axle stud 40. Threads are cut into the end most area 41 of the axle stud 40 for a length sufficient to receive the corresponding washers 21 and threaded nut 22 that secures the wheel assembly 20.

### U.S Patent Application No. 2012/0091673 Railcare Maintenance Creeper

A creeper is provided wherein the creeper has a main frame having a front, a rear, a first side, and an opposing second side. The main frame also includes wheels attached at the front and rear of the main frame, a handle attached at the rear of the main frame, and a rotatable platform. Pressure is applied to the handle thereby lifting the main frame onto railway tracks positioned under a railcar so that personnel can obtain access under the railcar and perform maintenance and work to the underside of the railcar.

### U.S Patent Application No. 2012/0235371 Multiposition Mechanic's Creeper

A multi-position mechanic's creeper for use by a worker wherein the creeper transforms into multiple working configurations for supporting the worker. The creeper includes a main creeper frame, a back frame pivotally connected with the main frame, and a seat frame pivotally carried by the back frame. A guide assembly is connected between a lower end of the back frame and the main frame to guide movement of the back frame from a flat configuration to an upright chair configuration. An inclination mechanism provides for adjusting the inclination of the back frame relative to the seat frame in a flat configuration to provide a plurality of inclined back configurations. A pair of side braces pivotally connect the main frame and back frame on opposing sides.

### U.S Patent Application No. 2012/0252666 Surface Preparation Support Apparatus and Method

A surface preparation support apparatus includes a creeper and a linear actuator. The linear actuator includes a base-end and a tool-end that is opposite the base-end. The base-end is coupled to the creeper. The tool-end is linearly movable relative to the base-end. A surface preparation tool is coupleable to the tool-end of the linear actuator. The surface preparation support apparatus also includes an actuator-controller. The actuator-controller is coupled to the linear actuator. The actuator-controller is operable to selectively actuate the linear actuator. The surface preparation support apparatus further includes a tool-controller. The tool-controller is configured to be coupled to the surface preparation tool. The tool-controller is operable to selectively energize the surface preparation tool.

### SUMMARY OF THE INVENTION

In one embodiment, the present invention includes a mechanical creeper that is designed to be used on top of framed walls during construction, although it should be understood that the mechanical creeper may be used in any number of situations. In one embodiment, the creeper includes a generally horizontal platform having a series of rotatable rollers disposed on an underside thereof. The horizontal platform includes a front transverse side, a rear transverse side and two longitudinal sides. Each longitudinal side of the platform is attached to a skid plate that is preferably attached thereto via hinge or other mechanism that allows the skid plates to pivot with respect to the platform. Each skid plate preferably includes a pivoting stirrup, wherein each stirrup includes a generally horizontal step member. In a preferred embodiment, a cushion is affixed to the upper surface of the platform.

In use, the wall-top mechanical creeper is placed on the top wall support so that the skid plates and stirrups are positioned in a downward vertical orientation on either side of the wall. The step members of the stirrups are preferably in a generally horizontal orientation for supporting a worker's feet. A worker may sit or lie on top of the horizontal platform (preferably on top of the cushion, which provides additional comfort to the worker), and when the worker is in a seated position, his feet may be supported on either side of the wall by the step members of the stirrups. The rollers allow the worker to roll forwards and backwards along the top of the wall.

### BRIEF DESCRIPTION OF THE DRAWINGS

These and other features, aspects, and advantages of the present invention will become better understood with regard to the following description, appended claims, and accompanying drawings where:

FIG. 1 is a side view of one embodiment of a wall-top mechanical creeper having a generally horizontal platform with a cushion positioned on a top surface thereof, a plurality of rollers operatively attached to an underside of the horizontal platform for rolling across a generally flat surface, pivoting skid plates extending along both longitudinal sides of the horizontal platform, and a pair of pivoting stirrups, each pivoting stirrup attached to a lower portion of a corresponding skid plate, wherein the wall-top mechanical creeper is positioned on top of a framed wall;

FIG. 2 is a front view of one embodiment of a wall-top mechanical creeper having a generally horizontal platform with a cushion positioned on a top surface thereof, a plurality of rollers operatively attached to an underside of the horizontal platform for rolling across a generally flat surface, pivoting skid plates extending along both longitudinal sides of the horizontal platform, and a pair of pivoting stirrups, each pivoting stirrup attached to a lower portion of a corresponding skid plate, wherein the wall-top mechanical creeper is positioned on top of a framed wall; and

FIG. 3 is a partial side cutaway view of a a wall-top mechanical creeper having a generally horizontal platform with a cushion positioned on a top surface thereof, a pair of rollers operatively attached to an underside of the horizontal platform for rolling across a generally flat surface, pivoting skid plates extending along both longitudinal sides of the horizontal platform, and a pair of pivoting stirrups, each pivoting stirrup attached to a lower portion of a corresponding skid plate, wherein the wall-top mechanical creeper is positioned on top of a framed wall.

### DETAILED DESCRIPTION OF THE INVENTION

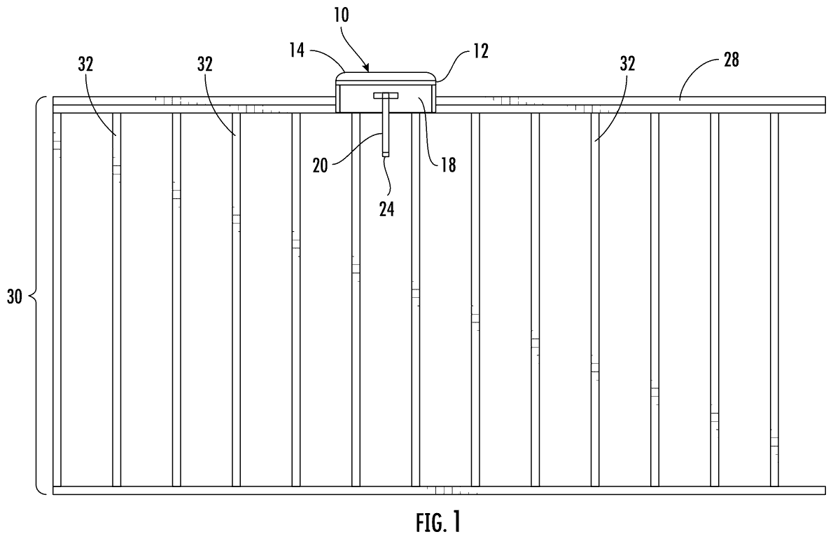

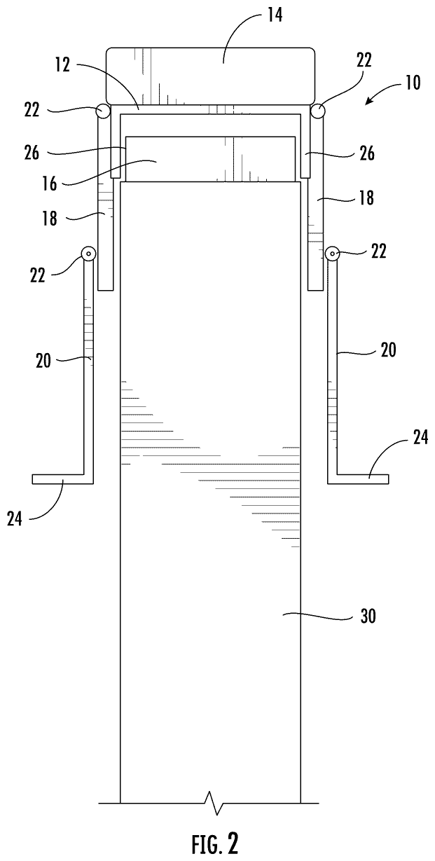

The present invention, in a first embodiment, includes a wall-top mechanical creeper 10 having a generally horizontal platform 12, preferably with a cushion 14 positioned on a top surface thereof, two or more rollers 16 operatively attached to an underside of the horizontal platform 12 for rolling across a generally flat surface, pivoting skid plates 18 extending downwardly from both longitudinal sides of the horizontal platform 12, and a pair of pivoting stirrups 20, each pivoting stirrup 20 attached to a lower portion of a corresponding skid plate 18, as shown in FIGS. 1-3. The skid plates 18 are preferably attached to the platform by hinges 22, so that the skid plates 18 may pivot to any desired angular position. During use, the skid plates 18 are oriented in a vertical position while work is being performed, and when a worker needs to turn a corner on top of a wall, the inner skid plate 18 may be raised to a generally horizontal orientation, so that the mechanical creeper 10 may be moved around the corner of the wall, and then the skid plate 18 may be repositioned in a vertical position. The skid plates 18, when they are disposed in a downwardly extending vertical position, extend below the bottom portion of the rollers and serve to maintain the mechanical creeper in proper alignment with the top portion of a wall when the mechanical creeper is in use, as shown in FIGS. 1-2.

Similarly, the stirrups 20 are preferably attached to the skid plate 18 via hinges 22, for similar reasons. The stirrups 20 have a step member 24 on a distal end thereof, for supporting the feet of a worker when the stirrups 20 are in a generally vertical orientation, as shown in FIGS. 1-3. The stirrups 20 may be pivotally repositioned to any desired position, including a horizontal position for repositioning the mechanical creeper around a corner along the top of a wall 26, and may be adjusted into an upward configuration, so that the stirrup 20 rests against the skid plate 18 in an upward direction for storage and/or transport. It is also contemplated that the step member 24 may be pivotally attached to the distal end of the stirrup 20 so that the step member 24 pivots between a generally right angle with respect to the stirrup 20 for supporting a worker's feet, or may be pivoted into a generally parallel configuration with respect to the stirrup 20 for storage and transport.

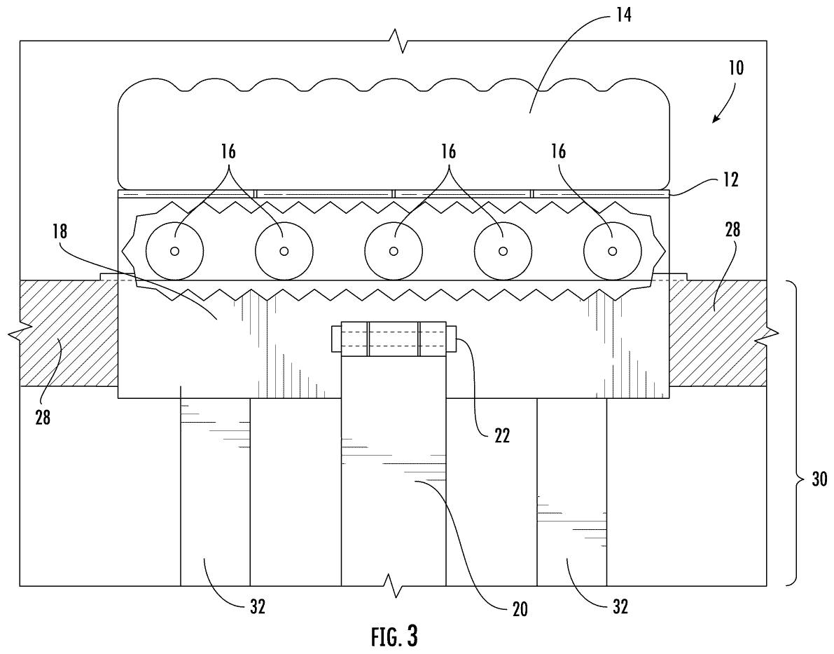

A cushion 14 is preferably positioned on an upper surface of the horizontal platform 12, and may be configured to be removably attached thereto. The rollers 16 are rotatably attached to the underside of the platform 12 in any suitable manner, examples of which are shown in FIGS. 2-3. For example, side supports 26 may be attached to the platform 12 along either longitudinal side thereof, and the rollers 16 may be rotatably attached to the side supports 26. Other types of attachment means may be used to rotatably attach the rollers 16 to the mechanical creeper 10, including brackets attached to an underside of the horizontal platform 12, or any other mechanisms for attaching the rollers thereto may be utilized, as will be recognized by those skilled in the art. Further, it is also contemplated that wheels may be used in place of rollers, as desired.

In use, the wall-top creeper 10 is placed on the top wall support 28 of a framed wall 30 having a series of support studs 32, so that the skid plates 18 and stirrups 20 are positioned in a downward vertical orientation on either side of the wall 30. The step members 24 of the stirrups 20 are preferably in a generally horizontal orientation for supporting a worker's feet. A worker may sit or lie on top of the horizontal platform 12 (preferably on top of the cushion 14, which provides additional comfort to the worker), and when the worker is in a seated position, his feet may be supported on either side of the wall 30 by the step members 24 of the stirrups 20. The rollers 16 allow the worker to roll forwards and backwards along the top of the wall 30. When the worker needs to turn a corner on top of the wall 30, the worker may raise one or both of the skid plates 18 and stirrups 20 in order to turn the mechanical creeper 10, so that the skid plate 18 and stirrup 20 do not prevent the mechanical creeper 10 from making the turn. Once the mechanical creeper 10 is newly positioned on the wall 30 (after the turn), then the skid plate 18 and stirrup 20 may be lowered back into the generally vertical position for continued work along the top of the new wall 30.

After the work has been performed, the mechanical creeper 10 may be removed from atop the wall 30, and the skid plates 18 and stirrups 20 (and step members 24, in some configurations) may be folded into a compact position for storage and transport.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A wall-top mechanical creeper comprising:
a generally horizontal platform member having a front side, a rear side and first and second longitudinal sides;
a plurality of rollers rotatably attached to an underside of said platform member;
a first skid plate attached to said first longitudinal side in a generally vertical orientation;
a second skid plate attached to said second longitudinal side in a generally vertical orientation; and
wherein said skid plates extend downwardly below said rollers.

2. The wall-top mechanical creeper set forth in claim 1, wherein said skid plates are pivotally attached to said platform member.

3. The wall-top mechanical creeper set forth in claim 1, further including a first stirrup attached to said first skid plate, and a second stirrup attached to said second skid plate.

4. The wall-top mechanical creeper set forth in claim 3, wherein said stirrups are pivotally attached to said skid plates.

5. The wall-top mechanical creeper set forth in claim 3, wherein said stirrups each include a generally horizontal step member.

6. The wall-top mechanical creeper set forth in claim 3, wherein said horizontal step members are pivotally attached to said stirrups.

7. The wall-top mechanical creeper set forth in claim 1, further including a cushion attached to an upper surface of said platform member.

8. The wall-top mechanical creeper set forth in claim 7, wherein said cushion is removably attached to said upper surface of said platform member.
